(19) United States
(12) Patent Application Publication
(10) Pub. No.: US 2012/0125264 A1
(43) Pub. Date: May 24, 2012

(54) Intelligent Climate Control in Domestic Animal Stables

(76) Inventor: Niels Skov Veng, Roslev (DK)

(21) Appl. No.: 13/320,546

(22) PCT Filed: May 12, 2010
(86) PCT No.: PCT/DK10/50104

§ 371 Date: Jan. 17, 2012

(30) Foreign Application Priority Data
May 15, 2009 (DK) PA 2009 00618

(51) Int. Cl. A01K 1/00

(52) U.S. Cl. 119/416

(57) ABSTRACT

It is a problem in stables when the animals have a behaviour different from the intended. The behaviour is changed if the animals are too hot or too cold. The air temperature is not sufficient information as this lacks information about air speed, feed consumption by the animals, animal activity and health condition of the animals. Measuring the surface temperature of the animals by infrared sensors will contain all of the above factors. This surface temperature may be used for controlling heating, covering and cooling measures.

### FIELD OF THE INVENTION

The present invention concerns a cover as indicated in claims 1-4 and a method as indicated in claims 5-10 for the arrangement and control of a cover in a double climate pen which allows for the varying heat production of the animals, depending on whether they are awake or asleep, and which uses an infrared temperature sensor for detecting the animals' condition under the cover.

### BACKGROUND OF THE INVENTION

In a modern animal production, in addition to a slotted area, a covering of a smaller area of the pen is used as well, see FIG. 1. The cover provides shelter for air movements from the ventilation plant. This also prevents rise of warm air from the animals which otherwise will draw colder air in from the sides.

From U.S. Pat. No. 2,870,966 is known a system for heating part of a pen area. At a rear wall of a pen, a heat box and a sheet over the heat box is arranged, the sheet extending with a slope out from the wall and covering part of the pen thereby. The heat box is supplied with much hot air which due to the metal structure of the heat box is transmitted as radiant heat to the pen area under the sheet. Substantial air movements are hereby obviated in the area under the sheet while simultaneously keeping the area warm. The system is intended for poultry stables and is adapted such that if the poultry becomes too hot under the sheet, they may move out into the remaining uncovered part of the pen.

A largely similar system is known from U.S. Pat. No. 1,808,364.

Another similar design is known from US 2008/0266115 where part of a pigpen is covered by a plate in which heat lamps are mounted. Hereby is created an area with higher temperature. The area is moreover physically separated from the pen in such a way that piglets have access to the heated area whereas the sow cannot come into it. The heating is relatively constant in the area and is either switched on or off.

The height of the cover is determined by practical experience so that the animals choose to lie under the cover. Since it is open to the stable itself, thermal air movements will occur when the warmer air under the cover seeks out, FIG. 2.

### OBJECT OF THE INVENTION

New research (4th CIGR report December 2002) proves that particularly young animals have great difference in their heat emission depending on whether they sleep or are active. The ratio for weaned pigs is 1:4.

This ratio means much to their experience under the cover. When they are awake lying under the cover, they can keep warm. But when they sleep it will be too cold. The bed area is therefore equipped with floor heating in an attempt to compensate.

When lowering the front edge of the cover, there is a smaller opening to the stable, FIG. 3. This will mean weaker thermal movements, and correspondingly there will be a lesser heat loss from the space under the cover and to the stable. It will thus be possible to lower the cover so far down that the animals may keep warm under it without floor heating, also when they are asleep. However, when awake they will emit up to four times as much heat why it will too hot under the cover. This will often entail that the animals lie outside and use the vacant area as toilet, whereby the floor becomes filled with faeces. This has to be shovelled away as it produces a massive emission of ammonia and water vapour which reduces productivity.

Thus it will be a great improvement if the position of the cover may automatically be changed depending on whether the animals are active or asleep, equalling large or small production of heat, respectively.

### DESCRIPTION OF THE INVENTION

It is thus the object of the invention to provide a cover and a method for regulating the climate in part of a pen by means of such a cover.

This is provided by a cover for covering at least part of a pen in stables for domestic animals, characterised in that the cover includes:
means for fastening a rear edge of the cover to a side of the pen, where the means allow turning of the cover in relation to the side of the pen;
one or more sensors mounted at the bottom side or top side of the cover or at a bracket fastened to a wall, where the sensors are heat sensors, in particular infrared temperature sensors, and/or where the sensors are a number of CO₂ sensors;
means for elevating and/or lowering the front edge of the cover opposite the rear edge where the cover is fastened to the side;
a control which receives input from the sensors and which on the basis of pre-defined parameters activates the means for elevating and/or lowering the edge of the cover.

One way of detecting the heat production of animals is to measure their surface temperature. If they have a great heat production, they have to get rid of this heat, and since they cannot lower the temperature in the stable, they are forced to increase their surface temperature.

By placing one or more infrared temperature sensors e.g. in the cover, they may measure the surface temperature of the animals and thereby their heat production. This is in turn evidence to whether they are asleep or active.

A control retrieves the measured surface temperature and compares it with a set temperature. If the measured temperature is too high, a signal is sent to a motor which either directly or via a wire drive lifts the front edge of the cover proportionally with the deviation in surface temperature.

It may be envisaged that the front edge of the cover is to go so far down that the animals, as they grow up, may reach to the cover. Therefore, the lowermost position of the front edge may depend on the animals' age and thereby their size. This relation may be incorporated in the control.

The exchange of air under the cover to the stable is also dependent on the temperature in the stable. The above mentioned lowermost position of the front edge of the cover will thus correspond to a certain stable temperature. It will thus be possible to raise the temperature in the stable if too low temperature is detected on the animals with the cover in the lowermost position. It will imply less thermal air movement, and warmer air is drawn in under the cover. However, it will consume much energy.

Another possibility is to install a heat system in the cover which may supply heat to the animals. The heat will then be increased steplessly as the detected surface temperature on the animals becomes too low. The use of floor heating will not be expedient as this form of heat is very sluggish, and there is a risk that an increase of the heat supply to the floor will only become noticeable when the animals have become awake and thus do not need the heat. This will imply a great waste of energy. Therefore, it will be practical with rapid radiant heat which also has the advantage that it does not heat the air, thereby increasing the thermal air movements. Supply of heat is only to take place when the edge of the cover has reached its lowermost position.

The risk that too little air is replaced between the space under the cover and the stable may arise. This may entail lower productivity. Lack of air may be detected by measuring the carbon dioxide content of the air. If too much carbon dioxide is detected under the cover, the front edge of it is to be raised such that more air is exchanged. At the same time, either the temperature in the stable must be increased or heat must be supplied under the cover.

In most cases, there will be several double climate pens in a stable. The animals will be of approximately the same age and will thus have the same needs. They will also simultaneously be fed and experience light, why they will have the same circadian rhythm of sleep and activity. The wire drive may therefore be provided for adjusting the cover position in common to a series of double climate pens or for the entire stable. In that connection, several pens, or all, will be equipped with infrared sensors. A control will calculate the average of the measured surface temperatures, and this value will be used for regulating the position of the covers.

A drawback is that one cannot see the animals with the cover in the lowermost position. The control is therefore equipped with an inspection function. Before entering the stable, this function is activated, and all covers are elevated to a pre-selected position that will allow a view under all covers. After inspection, automatic operation is selected again.

Additional preferred embodiments of the invention are defined in the dependent claims.

The invention moreover concerns a method for regulating the climate in an area of an animal stable with a cover according to claim 1, the cover being arranged at over a partial area in a double climate pen in stables for domestic animals, where sensors are arranged in connection with a control, where the sensors are heat sensors, including particularly infrared temperature sensors suited for detecting the surface temperature of the animals in the covered area and/or where the sensors are a number of CO₂ sensors suited for detecting the CO₂ concentration under the cover, so that the detected temperature or temperatures and/or the CO₂ concentrations are input parameters for the control, where the input parameters are compared with predefined limits, and that the control generates an output in case of input lying outside the predefined limits, causing the front edge of the cover is lowered or elevated, respectively, where the front edge of the cover can be lowered to such a low level that the heat loss to the stable corresponds to the heat emission of the animals in their sleeping condition and/or to a predetermined CO₂ concentration level, and where the front edge of the cover is elevated when the animals do not sleep and thereby produce more heat.

By this method it is ensured that optimal conditions are present in the covered part of the pen, both with regard to temperature and to oxygen content. Tests have clearly demonstrated that increased concentrations of CO₂ may have a very negative influence on the growth and well-being of the animals. It is therefore associated with additional advantages, besides providing a comfortable temperature (comfort zone), also to provide as high and good air quality as possible in the animals' living zones.

Additional advantages are indicated by the dependent claims.

### DESCRIPTION OF THE DRAWING

The invention will now be explained further with reference to the accompanying drawing, wherein

FIG. 1 shows a typical pen from above.

FIG. 2 shows a schematic illustration of a cover in horizontal (upper) position.

FIG. 3 shows a schematic illustration of a cover in lowered position.

FIG. 4 shows a double climate pen with pigs, the cover in the lowermost position and radiant heat being supplied.

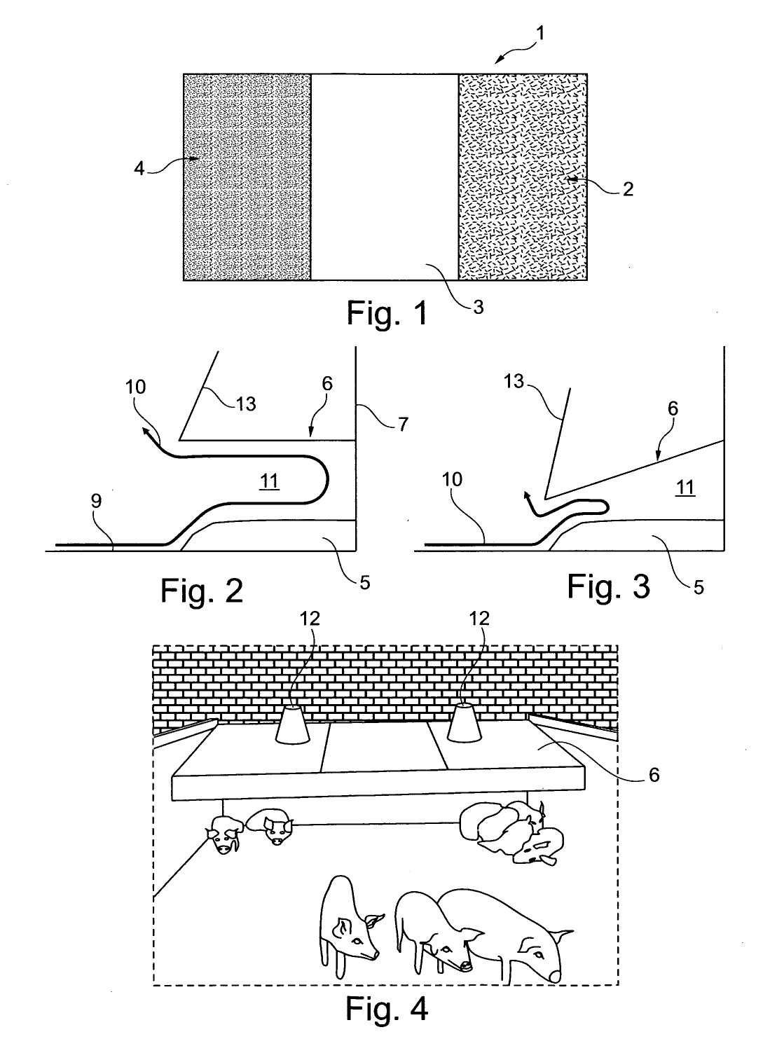

In FIG. 1 is illustrated a pigpen according to the invention as seen from above. The pen 1 is divided into three areas: a first covered area 2; a free zone 3 with ordinary floor; and a floor area 4 with slotted floor. The pigs may move about freely in the whole pen.

In FIGS. 2 and 3 appears an illustrated cross-section of the pen through floor and cover, i.e. mainly the first covered area 2 and the free zone 3. In this example, the covered area is furthermore provided with an insulating padding 5, a kind of mattress.

The cover 6 is pivotably attached to the rear wall 7 of the pen such that the front edge 8 of the cover may be disposed at various heights relative to the floor 9. This is illustrated in FIGS. 2 and 3.

The arrow 10 illustrates the normal airstream produced by the general ventilation system of the stable. As it clearly appears from FIGS. 2 and 3, there is a substantial difference in the air movement under the cover 6, depending on its position. By lowering the cover 6 as illustrated in FIG. 3, it is very limited how much air is getting in under the cover 6 whereby the heat will have difficulty in escaping. Hereby, a warm area is formed in the pen. This is particularly advantageous when the pigs are asleep/rest.

Conversely, it is important to regulate/control the temperature in the comfort zone 11 such that a suitable temperature is here and it is not too cold or too hot. By installing sensors measuring the surface temperature of the animals, a picture of their level of comfort is obtained. This is used as input for a control which may raise or lower the cover 6 such that the optimal temperature is attained in the comfort zone 11.

In order to further control the temperature, as illustrated in FIG. 4 heating lamps 12 may be arranged in the cover 6 whereby it is possible to raise the temperature in the comfort zone without increasing the air speed and thereby the risk of draft.

In addition to temperature measurements, the comfort zone may further be equipped with CO₂-sensors that detect the CO₂-content of the air. This is very important with regard to the well-being of the animals. By raising the cover and/or increasing the general level of ventilation of the stable, the amount of CO₂ may be reduced in the comfort zone.

The sensors are connected to a control controlling the position of the cover and which possibly communicates with a central computer such that it is possible to monitor/control a large number of pens centrally. The control activates a motor which adjusts the position of the cover in relation to the input, in the illustrated cases by pulling/easing off the wires 13.

1. A cover for covering at least part of a pen in stables for domestic animals, wherein the cover includes:
means for fastening a rear edge of the cover to a side of the pen, where the means allow turning of the cover in relation to the side of the pen;
one or more sensors mounted at the bottom side or top side of the cover or at a bracket fastened to a wall, where the sensors are heat sensors, including particularly infrared temperature sensors and/or where the sensors are a number of CO₂ sensors;
means for elevating and/or lowering the front edge of the cover opposite the rear edge where the cover is fastened to the side;
a control which receives input from the sensors and which on the basis of predefined parameters activates the means for elevating and/or lowering the edge of the cover.

2. Cover according to claim 1, wherein the means for elevating and/or lowering the front edge of the cover include wires connected to the cover at one end and to a motor at a second end, and that wires optionally may be coupled from other covers in other pens to the same motor, where the motor is controlled by the control.

3. Cover according to claim 1, wherein the control furthermore controls a number of heating elements which may adjust the temperature under the cover.

4. A method for regulating the climate in an area of an animal stable with a cover according to claim 1, the cover being arranged at least over a part area in a double climate pen in stables for domestic animals, where sensors are arranged in connection with a control, where the sensors are heat sensors, including particularly infrared temperature sensors suited for detecting the surface temperature of the animals in the covered area, and/or where the sensors are a number of CO₂ sensors suited for detecting the CO₂ concentration under the cover, so that the detected temperature or temperatures and/or the CO₂ concentrations are input parameters for the control, where the input parameters are compared with predefined limits, and wherein the control generates an output in case of input lying outside the predefined limits, causing the front edge of the cover to be lowered or elevated, respectively, where the front edge of the cover can be lowered to such a low level that the heat loss to the stable corresponds to the heat emission of the animals in their sleeping condition and/or to a predetermined CO₂ concentration level, and where the front edge of the cover is elevated when the animals do not sleep and thereby produce more heat.

5. Method according to claim 4, wherein the lowermost position of the front edge may be increased by the age of the animals.

6. Method according to claim 4, wherein the air temperature in the stable may be increased when too low temperature is detected under the cover, and vice versa.

7. Method according to claim 4, wherein heat is supplied under the cover when too low surface temperature is detected at the animals, the cover at the same time being at its lowermost position.

8. Method according to claim 4, wherein an inspection function may be activated whereby the cover is lifted to a previously determined position that allows a free view to all animals.

9. Method according to claim 4, wherein the lowermost position may also be determined by the content of CO₂ in the air under the cover and/or in the stable.
